(19) United States
(12) Patent Application Publication
(10) Pub. No.: US 2022/0171405 A1
(43) Pub. Date: Jun. 2, 2022

(54) CONTROL SYSTEM AND CONTROL METHOD FOR AUTOMATIC GUIDED VEHICLE

(71) Applicants: Hiromitsu ABE, Toyota-shi (JP); Kazunari ICHIKAWA, Toyota-shi (JP); Yutaka HASEGAWA, Nagoya-shi (JP); Ryuichi YOSHIDA, Toyota-shi (JP); Chiaki YOSHIWARA, Okazaki-shi (JP); Masaaki AKAGAWA, Toyota-shi (JP)

(72) Inventors: Hiromitsu ABE, Toyota-shi (JP); Kazunari ICHIKAWA, Toyota-shi (JP); Yutaka HASEGAWA, Nagoya-shi (JP); Ryuichi YOSHIDA, Toyota-shi (JP); Chiaki YOSHIWARA, Okazaki-shi (JP); Masaaki AKAGAWA, Toyota-shi (JP)

(73) Assignees: TOYOTA JIDOSHA KABUSHIKI KAISHA, Toyota-shi (JP); SHINMEI INDUSTRY CO., LTD., Toyota (JP)

(21) Appl. No.: 17/518,819

(22) Filed: Nov. 4, 2021

(30) Foreign Application Priority Data
Nov. 30, 2020 (JP) 2020-198086

(51) Int. Cl. G05D 1/02; G06K 9/00; G06K 19/06

(52) U.S. Cl. CPC G05D 1/0287; G05D 1/0274; G06K 2209/23; G06K 9/00664; G06K 19/06009; G05D 1/0214

(57) ABSTRACT

An integrated control system for an automatic guided vehicle in a vehicle production line includes: a plurality of the automatic guided vehicles each conveying a conveyance object which is a vehicle; a map construction unit that acquires a map of the vehicle production line; a position information acquisition unit that acquires position information of the plurality of the automatic guided vehicles on the map; a production instruction acquisition unit that acquires vehicle information of each of the vehicles conveyed by the plurality of the automatic guided vehicles; and an operation control unit that controls movement of each of the plurality of the automatic guided vehicles on the map based on the position information and the vehicle information.

### CROSS REFERENCE TO RELATED APPLICATIONS

This application is based upon and claims the benefit of priority from Japanese patent application No. 2020-198086, filed on Nov. 30, 2020, the disclosure of which is incorporated herein in its entirety by reference.

### BACKGROUND

The present disclosure relates to a control system and a control method for an automatic guided vehicle.

In recent years, use of an Automatic Guided Vehicle (AGV: also referred to as an unmanned conveyance vehicle) that automatically conveys a conveyance object (i.e., an object to be conveyed) in an unmanned manner has become widespread, and has been used in production sites and distribution sites. As related technology, for example, the technology disclosed in Japanese Unexamined Patent Application Publication No. 2018-092393 is known. Japanese Unexamined Patent Application Publication No. 2018-092393 discloses a system that collectively manages a plurality of automatic guided vehicles at a production site.

### SUMMARY

In Japanese Unexamined Patent Application Publication No. 2018-092393, a control system for an automatic guided vehicle controls movement of each automatic guided vehicle based on a map of a conveyance area set by a captured image and position information of the automatic guided vehicle in the map. However, Japanese Unexamined Patent Application Publication No. 2018-092393 does not take into account an influence of a conveyance object conveyed by the automatic guided vehicle on the system. Specifically, in vehicle production that produces vehicles, although a plurality of types of vehicles may be mounted on each automatic guided vehicle and then conveyed, it is difficult, according to Japanese Unexamined Patent Application Publication No. 2018-092393, to appropriately control the movement of the automatic guided vehicle in accordance with a vehicle to be conveyed.

The present disclosure has been made in view of the above-described circumstances and provides a control system and a control method for an automatic guided vehicle which are capable of appropriately controlling movement of the automatic guided vehicle in accordance with a vehicle to be conveyed.

A first exemplary aspect is a control system for an automatic guided vehicle in a vehicle production line, the control system including: a plurality of the automatic guided vehicles each configured to convey a vehicle; a map acquisition unit configured to acquire map information of the vehicle production line; a position information acquisition unit configured to acquire position information of the plurality of the automatic guided vehicles on the map information; a vehicle information acquisition unit configured to acquire vehicle information of each of the vehicles conveyed by the plurality of the automatic guided vehicles; and a control unit configured to control movement of each of the plurality of the automatic guided vehicles on the map information based on the position information and the vehicle information. According to this configuration, by controlling the automatic guided vehicles on the map using the vehicle information, it is possible to optimally perform a movement control in accordance with the vehicle.

In the first exemplary aspect, the control system further includes an image capturing unit configured to capture the vehicle production line, in which at least one of the map information, the position information, and the vehicle information may be acquired based on image information captured by the image capturing unit. According to this configuration, even when information is not acquired in advance, it is possible to collectively acquire information by the image capturing unit.

In the first exemplary aspect, the position information acquisition unit may acquire the position information by recognizing a recognition marker placed in the vehicle from the image information or by recognizing the vehicle from the image information. According to this configuration, it is possible to reliably know the position of the automatic guided vehicle on the map by means of the recognition marker and the image recognition of the vehicle.

In the first exemplary aspect, the map acquisition unit may set a stop position for each of work processes on the map information, and the control unit may stop the automatic guided vehicle based on the stop position and the position information on the map information corresponding to the vehicle information. According to this configuration, it is possible to stop the automatic guided vehicle for each work process in accordance with the vehicle.

In the first exemplary aspect, the control system further includes a virtual conveyance object generation unit configured to generate a virtual conveyance object based on the vehicle information, in which the control unit may stop the automatic guided vehicle based on position information of the virtual conveyance object and the stop position on the map information. According to this configuration, it is possible to optimally control stopping of each automatic guided vehicle in accordance with the vehicle information.

In the first exemplary aspect, the control unit may stop the automatic guided vehicle based on the vehicle information and intervals between the plurality of the automatic guided vehicles. According to this configuration, when the intervals between the vehicles are too short, it is possible to prevent any risk from occurring by stopping the vehicles.

In the first exemplary aspect, the control system further includes a virtual safety area generation unit configured to generate a virtual safety area around the vehicle based on the vehicle information, in which the control unit may stop the automatic guided vehicle based on overlapping of the virtual safety areas of preceding and following vehicles on the map information. According to this configuration, it is possible to optimally perform control of risk prevention in accordance with the vehicle information.

In the first exemplary aspect, the vehicle information may include at least one of information of a type of the vehicle, information of a size of the vehicle, and information of a destination country of the vehicle. According to this configuration, it is possible to optimally perform control based on these pieces of information.

Another exemplary aspect is a control method for an automatic guided vehicle in a vehicle production line, the control method including: conveying vehicles by a plurality of the automatic guided vehicles; acquiring map information of the vehicle production line; acquiring position information of the plurality of the automatic guided vehicles on the map information; acquiring vehicle information of each of the vehicles conveyed by the plurality of the automatic guided vehicles; and controlling movement of each of the plurality of the automatic guided vehicles on the map information based on the position information and the vehicle information. According to this method, by controlling the automatic guided vehicles on the map using the vehicle information, it is possible to optimally perform a movement control in accordance with the vehicle.

According to the present disclosure, it is possible to provide a control system and a control method for an automatic guided vehicle which are capable of appropriately controlling movement of the automatic guided vehicle in accordance with a vehicle to be conveyed.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a schematic configuration example of an integrated control system according to a first embodiment of the present disclosure;

FIG. 2 is a diagram showing an example of a vehicle production line according to the first embodiment of the present disclosure;

FIG. 3 is a diagram showing an example of a map of the vehicle production line according to the first embodiment of the present disclosure;

FIG. 4 is a diagram showing an example of a virtual conveyance object according to the first embodiment of the present disclosure;

FIG. 5 is a diagram for explaining a control example of an automatic guided vehicle according to the first embodiment of the present disclosure;

FIG. 6 is a diagram for explaining a control example of the automatic guided vehicle according to the first embodiment of the present disclosure;

FIG. 7 is a flowchart showing an example of a method for controlling the integrated control system according to the first embodiment of the present disclosure;

FIG. 8 is a flowchart showing an example of an operation control of the integrated control system according to the first embodiment of the present disclosure;

FIG. 9 is a diagram for explaining a control example of the integrated control system according to the first embodiment of the present disclosure;

FIG. 10 is a diagram for explaining a control example of the integrated control system according to the first embodiment of the present disclosure;

FIG. 11 is a diagram for explaining a control example of the integrated control system according to the first embodiment of the present disclosure; and

FIG. 12 is a diagram for explaining a control example of the integrated control system according to the first embodiment of the present disclosure.

### DESCRIPTION OF EMBODIMENTS

An embodiment of the present disclosure will be described hereinafter with reference to the drawings. However, the present disclosure is not limited to the embodiment shown below. Further, in order to clarify descriptions, the following descriptions and the drawings are partially omitted and simplified as appropriate. Note that the same symbols are assigned to the same elements throughout the drawings, and redundant descriptions are omitted as necessary.

### Overview of Example Embodiment

As described above, in the related technology disclosed in Japanese Unexamined Patent Application Publication No. 2018-092393 or the like, although the movement of the automatic guided vehicle can be controlled, it cannot be controlled in accordance with the vehicle since it is not considered to be applicable to a vehicle production line.

Further, in the related technology, control is only performed so that a workpiece or the like mounted on the automatic guided vehicle is conveyed in a predetermined area. Therefore, it is not assumed that the automatic guided vehicle and a person (an operator) cooperate with each other while safety is ensured. For example, the automatic guided vehicle disclosed in the related technology includes an object detection sensor as a basic component, and a scan is always performed along a traveling direction of the automatic guided vehicle and the side thereof by the object detection sensor during conveyance. Therefore, when the automatic guided vehicle attempts to work with a person, the automatic guided vehicle detects the nearby person as an obstacle and automatically stops or reduces its speed.

Further, in the related technology, the automatic guided vehicle cannot be used in continuous work processes. That is, the control system for an automatic guided vehicle disclosed in the related technology issues, as a basic function, a traveling instruction for each automatic guided vehicle from a traveling control panel. Therefore, it is not possible to collectively operate a plurality of automatic guided vehicles that continuously convey objects in like the case of continuous work processes. Note that continuous work processes indicate a production method in which in a vehicle production line including work processes that are continuously performed, a work object such as a workpiece is conveyed at a predetermined speed by, for example, a belt conveyor, and an operator continuously performs work such as assembling of the work object while moving in synchronization with the work object in each work process.

Therefore, in the embodiment of the present disclosure, it is possible to perform the continuous work processes by the automatic guided vehicle in the vehicle production line. That is, the embodiment of the present disclosure aims not only to perform conveyance of objects, but also to collectively manage the continuous operations of the automatic guided vehicles and to enable an operator to perform work such as assembly and inspection of conveyance objects mounted on the automatic guided vehicles in synchronization with the conveyance objects even during the conveyance of these objects. Further, the embodiment of the present disclosure provides an integrated control system that issues instructions for performing conveyance of objects and collectively manages a conveyance time and a working time by a predetermined takt time.

### First Embodiment

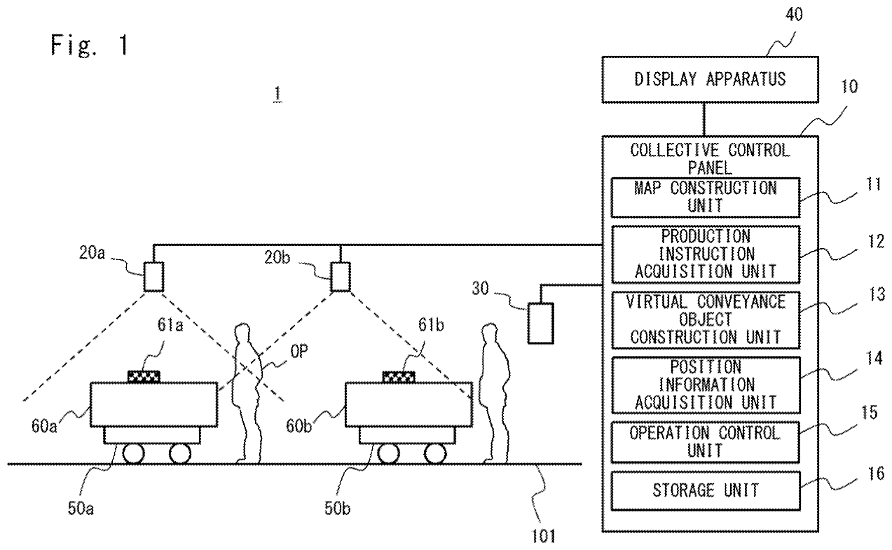

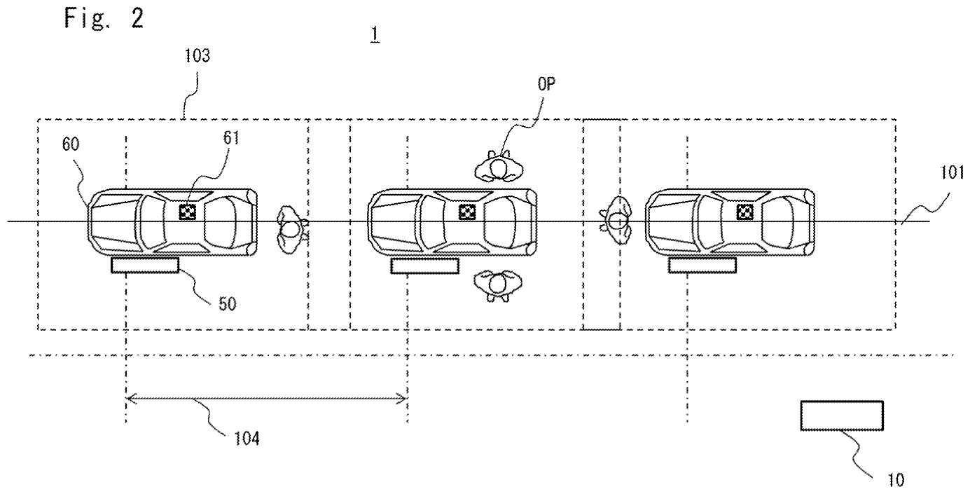

A first embodiment of the present disclosure will be described hereinafter with reference to the drawings. FIG. 1 shows a configuration example of an integrated control system according to this embodiment, and further shows an example of an image of a vehicle production line when viewed from the side thereof, the vehicle production line being controlled by the integrated control system. FIG. 2 shows an example of an image of the vehicle production line when viewed from above, the vehicle production line being controlled by the integrated control system. An integrated control system 1 according to this embodiment is a system that collectively manages (controls) a plurality of automatic guided vehicles in the continuous work processes of the vehicle production line.

As shown in FIG. 1, the integrated control system 1 includes a collective control panel 10, a plurality of cameras 20, a radio transceiver 30, a display apparatus 40, and a plurality of automatic guided vehicles 50.

The automatic guided vehicles 50 (e.g., the automatic guided vehicles 50a and 50b) load conveyance objects 60 (e.g., conveyance objects 60a and 60b) which are work objects, such as vehicles or workpieces, and convey the loaded conveyance objects 60 in accordance with control from the collective control panel 10. The automatic guided vehicle 50 includes the radio transceiver, receives a control instruction from the collective control panel 10 via the radio transceiver 30, and moves in accordance with the received control instruction. A guided vehicle identification number for identifying an automatic guided vehicle is assigned to each automatic guided vehicle 50, and a control instruction is issued upon the guided vehicle identification number of the automatic guided vehicle to be controlled being specified.

As shown in FIG. 2, the plurality of automatic guided vehicles 50 travel in a row in a conveyance direction (a traveling direction) on a traveling route 101 for the continuous work processes in the vehicle production line. For example, the traveling route 101 is set in advance for the automatic guided vehicle 50, and when the automatic guided vehicle 50 receives a forward instruction from the collective control panel 10, the automatic guided vehicle 50 travels on the traveling route 101 at a predetermined speed. In the continuous work processes, a work process indicated by a work process range 104 is continuously provided, and the automatic guided vehicle 50 conveys the conveyance object 60 in the order of the work processes that are continuously performed. For example, although one automatic guided vehicle 50 conveys one conveyance object 60 in each work process, a plurality of automatic guided vehicles 50 may convey a plurality of conveyance objects 60. In the work process range 104 of each work process, any number of operators OP in charge of the work process perform work while walking in synchronization with the moving conveyance object 60.

A position recognition marker 61 is placed at a predetermined position of each conveyance object 60 conveyed by the automatic guided vehicle 50. The position recognition marker 61 is a marker for the collective control panel 10 to recognize a position of the conveyance object 60 (the automatic guided vehicle 50). Predetermined information is set in advance in the position recognition marker 61, and the set information can be read from an image in which the position recognition marker 61 is captured. The position recognition marker 61 includes at least a marker identification number for identifying a marker, and may further include, for example, orientation information indicating an orientation of the marker. The position recognition marker 61 is, for example, an Augmented Reality (AR) marker, but may instead be another type of recognition marker capable of recognizing an identification number, such as a QR code (Registered Trademark) or a two-dimensional code other than the QR code.

As shown in FIG. 1, the plurality of cameras 20, the radio transceiver 30, and the display apparatus 40 are connected to the collective control panel 10. The camera 20 is an image capturing unit that captures the continuous work processes of the vehicle production line. For example, although one camera 20 is installed above the traveling route 101 of each work process, the plurality of cameras 20 may instead be installed in each work process. Each camera 20 captures a work process capturing area 103 from above and outputs the captured image to the collective control panel 10. The work process capturing area 103 captured by each camera 20 corresponds to the work process, and a part of the work process capturing area 103 of the preceding work process and a part of the work process capturing area 103 of the following work process overlap each other. For example, information (e.g., one of map information, position information, and vehicle information described later) necessary for the collective control panel 10 to perform control can be acquired from an image captured by the camera 20.

The radio transceiver 30 is a radio communication unit that transmits and receives radio signals to and from the plurality of automatic guided vehicles 50. The radio transceiver 30 wirelessly transmits a control instruction output from the collective control panel 10 to the automatic guided vehicle 50. The display apparatus 40 displays (outputs) a management state (a control state) of the continuous work processes of the vehicle production line to an administrator in accordance with processing of the collective control panel 10. The display apparatus 40 is a display that displays information (e.g., map information, a virtual conveyance object, and a virtual safety area described later) generated and detected by the collective control panel 10. Note that the radio transceiver 30 and the display apparatus 40 may be included in the collective control panel 10.

The collective control panel 10 is a management apparatus that collectively manages the continuous work processes of the vehicle production line and is also a control apparatus that collectively controls movement of each of the plurality of automatic guided vehicles 50. The collective control panel 10 may be an apparatus dedicated to the vehicle production line or an information processing apparatus such as a personal computer or a server computer. Note that functions necessary for the collective control panel 10 may be implemented by a plurality of any apparatuses. As shown in FIG. 1, the collective control panel 10 includes a map construction unit 11, a production instruction acquisition unit 12, a virtual conveyance object construction unit 13, a position information acquisition unit 14, an operation control unit 15, and a storage unit 16. The storage unit 16 stores information necessary for processing of each unit of the collective control panel 10. For example, the storage unit 16 stores information (information about the travelling route, the work process, the takt time, etc.) about the continuous work processes of the vehicle production line. The storage unit 16 may be an external storage device or a database.

The map construction unit (a map acquisition unit) 11 constructs (acquires) a map of the continuous work processes of the vehicle production line. The map is a virtual map in plan view showing an area of the continuous work processes of the vehicle production line, and shows the entire area where the automatic guided vehicles 50 move and the operators work. The map is two-dimensional map information generated from a plurality of two-dimensional images. For example, the map construction unit 11 acquires images captured by the plurality of cameras 20, and constructs (generates) one map by combining a plurality of acquired images.

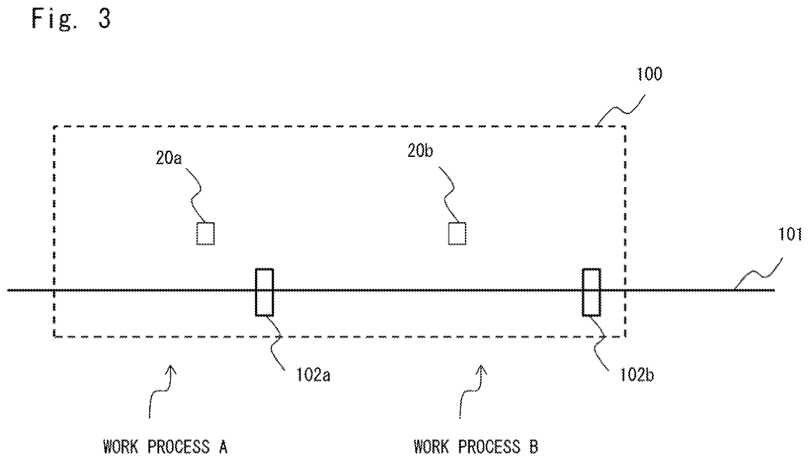

FIG. 3 shows an example of a map constructed by the map construction unit 11. The map construction unit 11, for example, combines two images captured by cameras 20a and 20b to generate a map 100. The map construction unit 11 sets the traveling route 101 in the map 100, and sets a virtual stop position 102 for stopping, for each work process, the automatic guided vehicle 50 (a virtual conveyance object) on the traveling route 101. For example, a virtual stop position 102a is set at a position where a work process A ends, and a virtual stop position 102b is set at a position where a work process B ends.

The production instruction acquisition unit 12 acquires production instruction information of a vehicle produced in the continuous work processes of the vehicle production line. For example, the production instruction acquisition unit 12 may receive the production instruction information from a production management apparatus or the like, or may instead receive the production instruction information input from an administrator. The production instruction information includes vehicle information such as a type of a vehicle conveyed by the automatic guided vehicle 50. It can be considered that the production instruction acquisition unit 12 is also a vehicle information acquisition unit that acquires the vehicle information. The vehicle information is not limited to a type of a vehicle, and may include information such as a size and a destination country of the vehicle. The vehicle information may be acquired from an image captured by the camera 20.

The virtual conveyance object construction unit (a virtual conveyance object generation unit) 13 constructs (generates) a virtual conveyance object corresponding to a vehicle to be produced based on production instruction information including the acquired vehicle information. The virtual conveyance object construction unit 13 constructs a virtual conveyance object for each vehicle information such as a type of a vehicle. For example, information about a virtual conveyance object corresponding to the vehicle information (a type, a size, a destination country, and the like of a vehicle) is stored in advance in the storage unit 16, and the information about the virtual conveyance object is acquired from the storage unit 16 based on the vehicle information included in the production instruction information. The virtual conveyance object is virtual information for knowing the position of the conveyance object 60 conveyed by the automatic guided vehicle 50 on the map, and is two-dimensional area information corresponding to a size of the conveyance object 60. The virtual conveyance object may include (images of) the conveyance object 60, the position recognition marker 61, and the automatic guided vehicle 50. Note that the virtual conveyance object may be generated based on not only the production instruction information but also other information. For example, information about a type of a vehicle may be included in the position recognition marker 61, and the virtual conveyance object may be generated based on the information about a type of a vehicle acquired from the position recognition marker 61. In this case, a marker is required for each work process and type of a vehicle. Further, information about the virtual conveyance object may be included in the position recognition marker 61, and the virtual conveyance object may be directly generated from the position recognition marker 61.

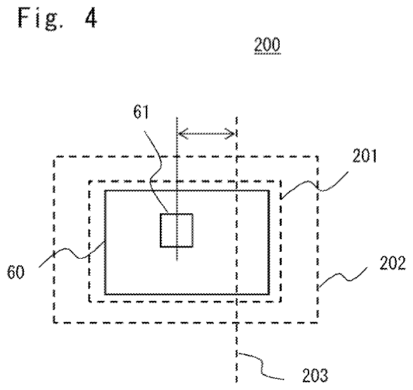

FIG. 4 shows an example of a virtual conveyance object constructed by the virtual conveyance object construction unit 13. The virtual conveyance object construction unit 13 acquires a size (a dimension) of the conveyance object 60 as information necessary for construction from vehicle information, such as a type of a vehicle, included in production instruction information, and generates a virtual conveyance object 201 having a size corresponding to (the same as) the size of the conveyance object 60. The virtual conveyance object 201 is an area including the conveyance object 60 and the position recognition marker 61 and having a shape conforming to the shape of the conveyance object 60, for example, a rectangular shape surrounding a vehicle, but it may instead have any other shape. Further, the virtual conveyance object construction unit 13 sets, in the virtual conveyance object 201, a virtual stop reference point (a reference line) 203 that is a reference for stopping the conveyance object 60 at the virtual stop position 102. The virtual stop reference point 203 is set at a position on the front side of the conveyance direction in the virtual conveyance object 201 and at a predetermined distance from the position recognition marker 61 in the conveyance direction (the traveling direction of the automatic guided vehicle). Since the virtual conveyance object 201 is generated based on the vehicle information, it can be considered that the virtual stop reference point 203 is also set based on the vehicle information.

Further, the virtual conveyance object construction unit 13 generates, outside the virtual conveyance object 201, a virtual safety area 202 for preventing an operator from being caught between the conveyance objects. The virtual conveyance object construction unit 13 is also a virtual safety area generation unit that generates a virtual safety area. The virtual safety area 202 is virtual information for ensuring the safety of an area around the conveyance object (the vehicle). The virtual safety area 202 is an area surrounding the virtual conveyance object 201 and is larger than the virtual conveyance object 201 by a predetermined size. The virtual safety area 202 is an area having a shape conforming to the shape of the virtual conveyance object 201, and is, for example, a rectangular area like that of the virtual conveyance object 201, but may instead have any other shape. Since the virtual conveyance object 201 is generated based on the vehicle information, it can be considered that the virtual safety area 202 is also generated based on the vehicle information.

The position information acquisition unit 14 acquires position information of the conveyance object 60 (the automatic guided vehicle 50) on the map. The position information acquisition unit 14 acquires an image captured by the camera 20, and acquires the position of the conveyance object 60 (the virtual conveyance object 201) by means of the position recognition marker 61 included in the acquired image. The position information acquisition unit 14 acquires the position of the conveyance object 60 in the map from the coordinates of the position recognition marker 61 in the image, and specifies the conveyance object 60 and the automatic guided vehicle 50 from the marker identification number acquired from the position recognition marker 61. Note that the position of the conveyance object 60 is not limited to being acquired using the position recognition marker, and may instead be acquired by other methods. For example, the position of a vehicle (a conveyance object) may be acquired by recognizing the vehicle in an image by using an image recognition technology using machine learning or the like. Alternatively, a Global Positioning System (GPS) receiver may be attached to the conveyance object 60 to acquire position information detected by the GPS receiver, whereby the position of the conveyance object 60 may be acquired.

The operation control unit 15 operates the continuous work processes of the vehicle production line by collectively controlling the automatic guided vehicles 50. The operation control unit 15 performs a collective line operation for monitoring work progress, position information, and safety of all the automatic guided vehicles 50 on the vehicle production line. The operation control unit 15 controls movement of the automatic guided vehicle 50 based on the acquired position information. The operation control unit 15 controls movement of the automatic guided vehicle 50 on the map based on the position information of the conveyance object (the automatic guided vehicle) and the vehicle information. Specifically, the operation control unit 15 stops the automatic guided vehicle 50 based on the position of the virtual conveyance object (the virtual stop reference point) and the virtual stop position on the map. Further, the operation control unit 15 stops the automatic guided vehicle 50 based on the vehicle information and intervals between a plurality of conveyance objects (automatic guided vehicles). Specifically, the operation control unit 15 stops the automatic guided vehicle 50 based on overlapping of the virtual safety areas of the preceding and following vehicles on the map.

The operation control unit 15 associates vehicle type information of the conveyance object 60, the position recognition marker 61, and the automatic guided vehicle 50 with each other in advance before the automatic guided vehicle 50 starts (enters) the continuous work processes, and stores the associated information in the storage unit 16. The operation control unit 15 transmits, via the radio transceiver 30, a forward instruction to the automatic guided vehicle 50 that has started the continuous work processes. The operation control unit 15 transmits a forward instruction or a stop instruction for each automatic guided vehicle 50. The operation control unit 15 moves all the automatic guided vehicles 50 forward at the same timing or stops all the automatic guided vehicles 50 at the same timing. The operation control unit 15 stops all the automatic guided vehicles 50 when the automatic guided vehicle 50 arrives at one of the virtual stop positions 102. The operation control unit 15 counts the working time after all the automatic guided vehicles 50 are stopped, and performs the operation along a determined line takt time. Note that the operation control unit 15 may move the respective automatic guided vehicles 50 forward at different timings or stop the respective automatic guided vehicles 50 at different timings. For example, the operation control unit 15 may stop only the automatic guided vehicle 50 that has arrived at the virtual stop position 102.

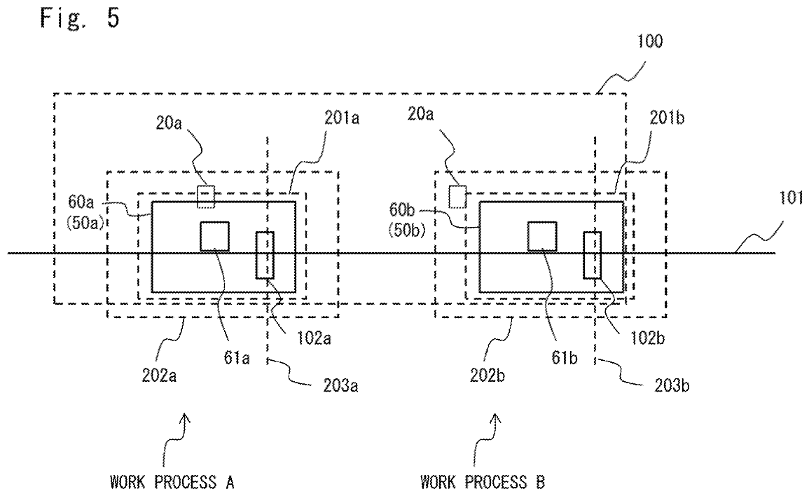

FIG. 5 shows an example of an operation control of the automatic guided vehicle in the continuous work processes. For example, the automatic guided vehicle 50a conveys the conveyance object 60a in the work process A, and, the automatic guided vehicle 50b conveys the conveyance object 60b in the work process B. When the position acquired by a position recognition marker 61a of the conveyance object 60a reaches the stop position of the work process A, or when the position acquired by the position recognition marker 61b of the conveyance object 60b reaches the stop position of the work process B, the automatic guided vehicle 50a conveying the conveyance object 60a and the automatic guided vehicle 50b conveying the conveyance object 60b are stopped. Specifically, when a virtual stop reference point 203a of the conveyance object 60a in a virtual conveyance object 201a overlaps with the virtual stop position 102a of the work process A, or when a virtual stop reference point 203b of the conveyance object 60b in a virtual conveyance object 201b overlaps with the virtual stop position 102b of the work process B, the automatic guided vehicles 50a and 50b are stopped.

Further, when intervals between the automatic guided vehicles 50 (the conveyance objects 60) during conveyance are shorter than predetermined intervals, the operation control unit 15 brings all the automatic guided vehicles 50 to an emergency stop in order to ensure the safety of an operator. The operation control unit 15 constantly monitors the intervals between the automatic guided vehicles 50 (the conveyance objects 60), and when the virtual safety areas 202 overlap each other, the operation control unit 15 determines that the intervals between the automatic guided vehicles 50 are short and thus there is a risk that an operator may be caught between the automatic guided vehicles 50. Then the operation control unit 15 brings all the automatic guided vehicles 50 to an emergency stop. In this embodiment, the object detection sensor of the automatic guided vehicle is not used in order to operate as continuous work processes. Thus, the conveyance state is always maintained except in the case of an abnormality occurring. Therefore, by the operation control unit 15 constantly monitoring the intervals between the preceding and following automatic guided vehicles (conveyance objects) as a function in place of the object detection sensor, safety is ensured.

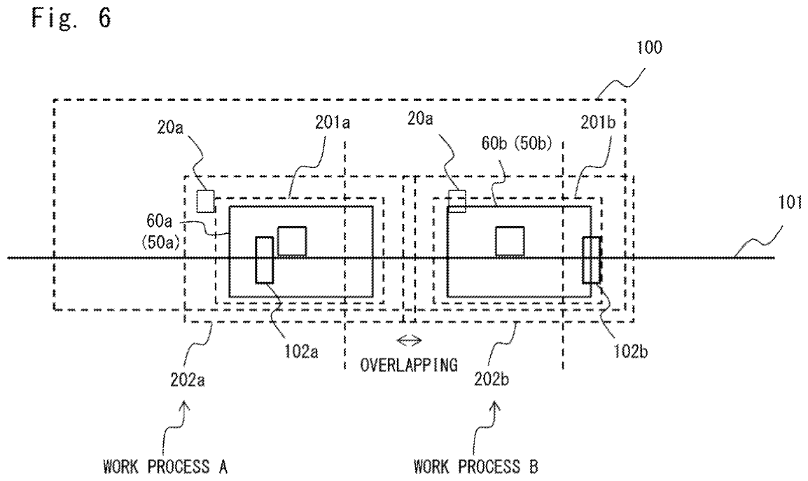

FIG. 6 shows an example of an emergency stop control of the automatic guided vehicle in the continuous work processes. For example, when the interval between the conveyance objects 60a and 60b is shorter than a predetermined interval, the automatic guided vehicle 50a conveying the conveyance object 60a and the automatic guided vehicle 50b conveying the conveyance object 60b are stopped. Specifically, when a virtual safety area 202a of the conveyance object 60a overlaps with a virtual safety area 202b of the conveyance object 60b, the automatic guided vehicles 50a and 50b are stopped.

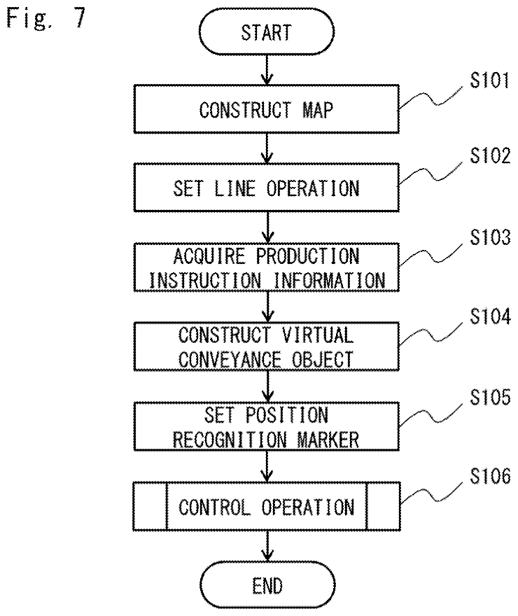

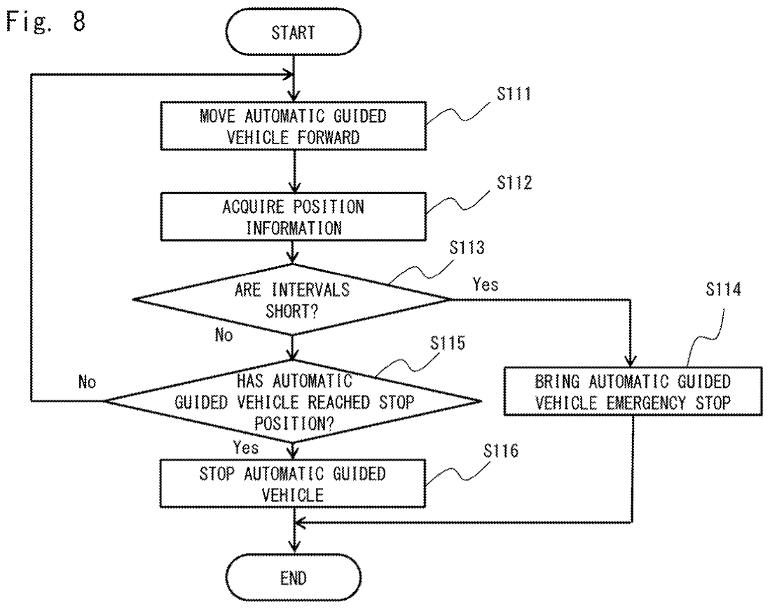

FIG. 7 shows an example of a method for controlling an integrated control system according to this embodiment, and FIG. 8 shows an example of an operation control in FIG. 7.

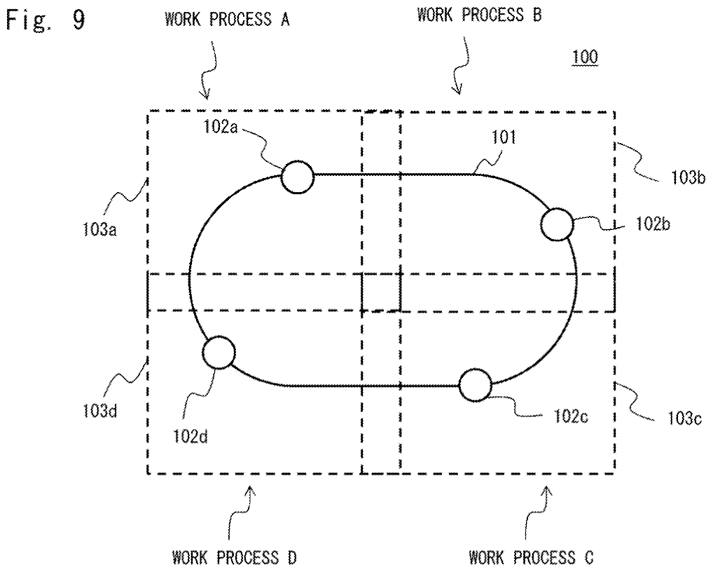

As shown in FIG. 7, first, the collective control panel 10 constructs a map of the continuous work processes (S101), and performs an operation setting of the vehicle production line in the constructed map (S102). FIG. 9 shows a specific example of the map constructed at this time. For example, four cameras 20 respectively capture four images of work process capturing areas 103a to 103d of work processes A to D. The map construction unit 11 acquires the four images of the work process capturing areas 103a to 103d, and generates the map 100 by combining the four images as shown in FIG. 9. Further, the map construction unit 11 sets the traveling route 101 and the virtual stop position 102 in the generated map 100 as the operation setting. For example, based on the work contents, the working time, and the like of each work process, the traveling route 101 that is continuously formed in the work processes A to D is set in the map 100, and virtual stop positions 102a to 102d are set on the traveling route 101 of the work processes A to B. For example, the generated map 100 may be displayed on the display apparatus 40.

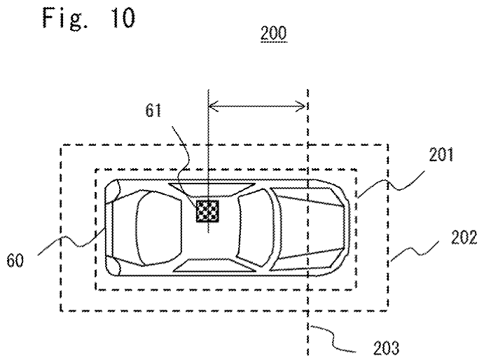

Next, the collective control panel 10 acquires production instruction information of a vehicle to be produced (S103), and constructs a virtual conveyance object based on the acquired production instruction information (S104). The production instruction acquisition unit 12 acquires the production instruction information of the vehicle to be produced in the continuous work processes from a production management apparatus or the like. For example, the production instruction information includes assembly sequence numbers for assembling parts, a body number for identifying a body of a vehicle, a program number for identifying a type of a vehicle, and the like. The virtual conveyance object construction unit 13 constructs the virtual conveyance object in accordance with the program number included in the production instruction information. FIG. 10 shows a specific example of the virtual conveyance object constructed at this time. The information of FIG. 10 is stored in advance in the storage unit 16 for each program number. For example, the program number (the type of the vehicle) is associated with information indicating the virtual conveyance object 201, the virtual stop reference point 203, and the virtual safety area 202, and then images or the like of the conveyance object 60 and the position recognition marker 61 are associated with this information as necessary and the associated information is stored. The virtual conveyance object construction unit 13 refers to the storage unit 16 and acquires (constructs) the virtual conveyance object 201, the virtual stop reference point 203, the virtual safety area 202, and the like corresponding to the program number.

Next, the collective control panel 10 sets a position recognition marker in the vehicle to be produced (S105). For example, when the automatic guided vehicle 50 starts (enters) the continuous work processes, an operator places the position recognition marker 61 at a predetermined position of the conveyance object 60. The operation control unit 15 acquires an image captured by the camera 20, and detects the position recognition marker 61 of the conveyance object 60 and the automatic guided vehicle 50 starting the continuous work processes. An image may be acquired by installing the camera in front of the continuous work processes, or an image captured by the camera installed in the continuous work processes may be acquired. In order to control the automatic guided vehicle 50, the guided vehicle identification number of the automatic guided vehicle 50 is previously known. Then, the operation control unit 15 associates the virtual conveyance object corresponding to the program number, the marker identification number of the position recognition marker 61, and the guided vehicle identification number of the automatic guided vehicle 50 with each other, and stores the associated information in the storage unit 16.

For example, when the automatic guided vehicle 50 having a guided vehicle identification number “A1” starts the continuous work processes, the guided vehicle identification number “A1”, a program number “P1” (the virtual conveyance object) of the acquired production instruction information, and a marker identification number “M1” of the detected position recognition marker 61 are associated with each other. Next, when the automatic guided vehicle 50 having a guided vehicle identification number “A2” starts the continuous work processes, the guided vehicle identification number “A2”, a program number “P2”, and a marker identification number “M2” are associated with each other. Next, when the automatic guided vehicle 50 having a guided vehicle identification number “A3” starts the continuous work processes, the guided vehicle identification number “A3”, a program number “P3”, and a marker identification number “M3” are associated with each other.

Next, the collective control panel 10 performs an operation control of the continuous work processes (S106). Specifically, in the operation control of the continuous work processes, the processes of FIG. 8 are repeated.

As shown in FIG. 8, the collective control panel 10 moves the automatic guided vehicle 50 forward (S111), and acquires position information of the automatic guided vehicle 50 (the conveyance object 60) (S112). The operation control unit 15 transmits a forward instruction to the automatic guided vehicle 50 which has started the continuous work processes. For example, when the automatic guided vehicle 50 having the guided vehicle identification number “A1” starts the continuous work processes, the operation control unit 15 transmits a forward instruction including the guided vehicle identification number “A1”, and the automatic guided vehicle 50 having the guided vehicle identification number “A1” moves forward on the traveling route. Similarly, when the automatic guided vehicles 50 having the guided vehicle identification numbers “A2” and “A3”, respectively, start the continuous work processes, the operation control unit 15 transmits forward instructions including the guided vehicle identification numbers “A2” and “A3”, respectively. Each automatic guided vehicle 50 continues to move forward on the traveling route until it receives a stop instruction.

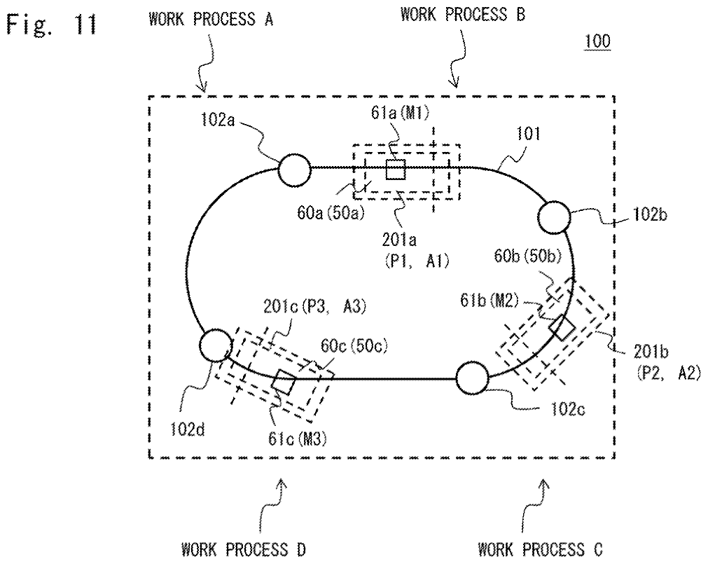

Further, the position information acquisition unit 14 acquires position information of all the conveyance objects 60 (the automatic guided vehicles 50) in the continuous work processes by means of the position recognition markers 61 placed in the respective conveyance objects 60. FIG. 11 shows a specific example of the virtual conveyance object 201 in the position information acquired at this time. For example, the position information acquisition unit 14 extracts the position recognition marker 61a of the conveyance object 60a, a position recognition marker 61b of the conveyance object 60b, and a position recognition marker 61c of a conveyance object 60c from images captured by the plurality of cameras 20, and acquires the positions of the position recognition markers 61a to 61c on the map 100. When the marker identification number “M1” of the position recognition marker 61a is acquired, the position of the virtual conveyance object 201a of the program number “P1” and the position of the automatic guided vehicle 50a of the guided vehicle identification number “A1” are specified by the aforementioned association. Similarly, the position of the virtual conveyance object 201b of the program number “P2” and the position of the automatic guided vehicle 50b of the guided vehicle identification number “A2” are specified by the marker identification number “M2” of the position recognition marker 61b, and the position of a virtual conveyance object 201c of the program number “P3” and the position of an automatic guided vehicle 50c of the guided vehicle identification number “A3” are specified by the marker identification number “M3” of the position recognition marker 61c. Then, as shown in FIG. 11, the virtual conveyance objects 201a to 201c are associated with the detected respective positions on the map 100. Further, by acquiring orientation information from the position recognition marker 61, it is possible to arrange the virtual conveyance objects 201a to 201c on the map 100 in the acquired orientation. The position information acquisition unit 14 periodically repeats acquisition of position information and updates the positions (and the orientations) of the virtual conveyance objects 201a to 201c on the map 100. For example, the map 100 is displayed on the display apparatus 40, and the virtual conveyance objects 201a to 201c are displayed on the map 100 in accordance with the detected respective positions (and orientations). By doing so, it is possible to monitor movement of the conveyance object 60 (the automatic guided vehicle 50).

Next, the collective control panel 10 determines whether or not intervals between the automatic guided vehicles 50 (the conveyance objects 60) are shorter than predetermined values (S113), and if the collective control panel 10 determines that the intervals are shorter than the predetermined values, it brings the automatic guided vehicles 50 to an emergency stop (S114). For example, the operation control unit 15 constantly monitors the interval between the virtual conveyance objects 201a and 201b, the interval between the virtual conveyance objects 201b and 201c, and the interval between the virtual conveyance objects 201c and 201a.

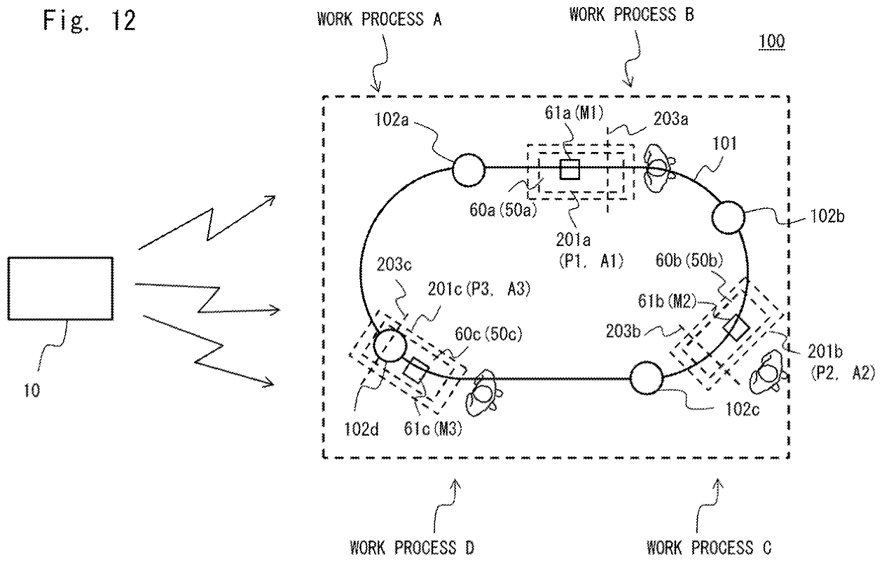

When the virtual safety area 202a of the virtual conveyance object 201a overlaps with the virtual safety area 202b of the virtual conveyance object 201b, when the virtual safety area 202b of the virtual conveyance object 201b overlaps with a virtual safety area 202c of the virtual conveyance object 201c, or when the virtual safety area 202c of the virtual conveyance object 201c overlaps with the virtual safety area 202a of the virtual conveyance object 201a, the operation control unit 15 stops all the automatic guided vehicles 50. The operation control unit 15 may transmit one emergency stop instruction to all the automatic guided vehicles 50, or may instead transmit a plurality of stop instructions including the guided vehicle identification numbers “A1”, “A2”, and “A3”, respectively. For example, the virtual conveyance objects 201 for which it is determined the intervals between them are short may be highlighted on the display apparatus 40, for example, by changing the colors thereof. In the event of an emergency stop, the operation control is stopped until an administrator confirms the situation is safe (until the administrator instructs a resumption of the operation control). Further, if the collective control panel 10 determines that the automatic guided vehicles 50 are operated at an interval equal to or greater than the predetermined value, the collective control panel 10 determines whether or not the position of the automatic guided vehicle 50 has reached the stop position (S115). If the collective control panel 10 determines that the position of the automatic guided vehicle 50 has not reached the stop position, the collective control panel 10 repeats the process of S111 and the subsequent processes until the position of the automatic guided vehicle 50 reaches the stop position, while if the collective control panel 10 determines that the position of the automatic guided vehicle 50 has reached the stop position, the collective control panel 10 stops the automatic guided vehicle 50 (S116). FIG. 12 shows a specific example of the virtual conveyance object 201 for which a stop control is performed at this time. For example, the operation control unit 15 monitors the positions of the virtual conveyance objects 201a, 201b, and 201c, and determines whether or not these positions have reached the virtual stop positions 102a to 102d. When the virtual stop reference point 203a of the virtual conveyance object 201a overlaps with the virtual stop position 102b, when the virtual stop reference point 203b of the virtual conveyance object 201b overlaps with the virtual stop position 102c, or when a virtual stop reference point 203c of the virtual conveyance object 201c overlaps with the virtual stop position 102d, all the automatic guided vehicles 50 are simultaneously stopped. In the example of FIG. 12, since the virtual stop reference point 203c of the virtual conveyance object 201c and the virtual stop position 102d overlap each other, a plurality of stop instructions including the guided vehicle identification numbers “A1”, “A2”, and “A3”, respectively, are transmitted. Note that, in this case, control may be performed so that only the automatic guided vehicle 50c having the guided vehicle identification number “A3” is stopped. For example, a forward instruction including the guided vehicle identification number “A1”, a forward instruction including the guided vehicle identification number “A2”, and a stop instruction including the guided vehicle identification number “A3” may be transmitted and then movement of each of the automatic guided vehicles 50 may be individually controlled. Subsequently, after the elapse of a predetermined period for starting a next process, all the automatic guided vehicles 50 are simultaneously moved forward, and the operation control of FIG. 8 is repeated.

As described above, in this embodiment, it is possible to operate the continuous work processes by collectively controlling the automatic guided vehicles that convey conveyance objects such as vehicles in the vehicle production line. By knowing the positions of a plurality of virtual automatic guided vehicles on the map of the continuous work processes, it is possible to collectively control movement of each of a plurality of automatic guided vehicles. The continuous work processes enable more efficient work, so that it is possible to increase the amount of production, and to produce a variety of types and a variety of amounts of vehicles. Further, by generating a virtual automatic guided vehicle in accordance with a type or the like of a vehicle to be conveyed, it is possible to perform a movement control corresponding to the vehicle. Further, by generating a virtual safety area in accordance with the type or the like of the vehicle and monitoring intervals between the vehicles, it is possible to ensure the safety of an operator.

Note that the present disclosure is not limited to the above-described embodiment and may be modified as appropriate without departing from the spirit of the present disclosure. For example, in the above-described embodiment, a description is given of an example in which vehicles are produced by causing the automatic guided vehicles to convey mainly vehicles. However, the objects conveyed by the automatic guided vehicles are not limited to vehicles, and other work objects may instead be produced by causing the automatic guided vehicles to convey other work objects.

Each component in the above-described embodiment may be configured by software, hardware, or both of them, and may be configured by one piece of hardware or software, or a plurality of pieces of hardware or software. The function (processing) of each apparatus may be implemented by a computer including a Central Processing Unit (CPU), a memory, and the like. For example, the function (processing) of each apparatus may be implemented by storing, in a storage device, a program for performing a method (e.g., a control method) in the embodiment and causing the CPU to execute the program stored in the storage device.

The above programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.).

The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A control system for an automatic guided vehicle in a vehicle production line, the control system comprising:
a plurality of the automatic guided vehicles each configured to convey a vehicle;
a map acquisition unit configured to acquire map information of the vehicle production line;
a position information acquisition unit configured to acquire position information of the plurality of the automatic guided vehicles on the map information;
a vehicle information acquisition unit configured to acquire vehicle information of each of the vehicles conveyed by the plurality of the automatic guided vehicles; and
a control unit configured to control movement of each of the plurality of the automatic guided vehicles on the map information based on the position information and the vehicle information.

2. The control system according to claim 1, further comprising an image capturing unit configured to capture the vehicle production line,
wherein at least one of the map information, the position information, and the vehicle information is acquired based on image information captured by the image capturing unit.

3. The control system according to claim 2, wherein the position information acquisition unit acquires the position information by recognizing a recognition marker placed in the vehicle from the image information or by recognizing the vehicle from the image information.

4. The control system according to claim 1, wherein
the map acquisition unit sets a stop position for each of work processes on the map information, and
the control unit stops the automatic guided vehicle based on the stop position and the position information on the map information corresponding to the vehicle information.

5. The control system according to claim 4, further comprising a virtual conveyance object generation unit configured to generate a virtual conveyance object based on the vehicle information,
wherein the control unit stops the automatic guided vehicle based on position information of the virtual conveyance object and the stop position on the map information.

6. The control system according to claim 1, wherein the control unit stops the automatic guided vehicle based on the vehicle information and intervals between the plurality of the automatic guided vehicles.

7. The control system according to claim 6, further comprising a virtual safety area generation unit configured to generate a virtual safety area around the vehicle based on the vehicle information,
wherein the control unit stops the automatic guided vehicle based on overlapping of the virtual safety areas of preceding and following vehicles on the map information.

8. The control system according to claim 1, wherein the vehicle information includes at least one of information of a type of the vehicle, information of a size of the vehicle, and information of a destination country of the vehicle.

9. A control method for an automatic guided vehicle in a vehicle production line, the control method comprising:
conveying vehicles by a plurality of the automatic guided vehicles;
acquiring map information of the vehicle production line;
acquiring position information of the plurality of the automatic guided vehicles on the map information;
acquiring vehicle information of each of the vehicles conveyed by the plurality of the automatic guided vehicles; and
controlling movement of each of the plurality of the automatic guided vehicles on the map information based on the position information and the vehicle information.
